(19) United States
(12) Patent Application Publication
(10) Pub. No.: US 2016/0374274 A1
(43) Pub. Date: Dec. 29, 2016

(54) APPARATUS AND METHOD FOR GROWING PLANTS

(71) Applicant: Ron Tyler Johnson, Oklahoma City, OK (US)

(72) Inventor: Ron Tyler Johnson, Oklahoma City, OK (US)

(21) Appl. No.: 14/749,279

(22) Filed: Jun. 24, 2015

(51) Int. Cl. A01G 9/02; A01G 9/12; A01G 13/10

(52) U.S. Cl. CPC A01G 9/02; A01G 13/105; A01G 9/12

(57) ABSTRACT

An apparatus for growing a plant. The apparatus includes a tubular member, an annular structure extending from the tubular member, and a screen extending across a bottom end of the tubular member. The tubular member defines as a plant receiving chamber, and the annular structure defines an annular channel for receiving a chemical pesticide. The screen extending across the bottom of the tubular member is formed of mesh sized to allow fluid to exit the bottom end of the tubular member and is sized to inhibit pests from entering the bottom end of the tubular member.

### BACKGROUND

For years, gardeners have struggled to control garden pests from destroying their plants. Garden pests include insects, birds, rodents, and other types of living things. Different types of garden pests access and affect plants in a variety of ways. Some garden pests are borers and make holes in plant or rock materials. Other garden pests (e.g., beetles) burrow in the earth and access a plant at its roots and some crawl or climb onto the plant from ground level. Still other garden pests are jumpers (e.g., grasshoppers) or flyers (e.g., cabbage moths) that leap onto or land on the plant. The various ways in which different types of garden pests access a plant make the plant vulnerable to attack on multiple fronts.

In order to deter or kill garden pests, some gardeners have used chemical pesticides directly on their plants, and different types of chemical pesticides have been developed and are affective at targeting, repelling, or killing a range of garden pests. However, for various reasons, many consumers do not want to grow or eat plants that have been treated directly with chemical pesticides or toxins. For example, chemical pesticides can have harmful effects on gardeners, nearby children, birds, or domestic pets. Other solutions for deterring or killing garden pests include disposing a plant in an enclosure surrounded by a single pesticide. However, this approach does not address burrowing pests that attack a plant disposed in the earth, and this approach is generally limited to using one type of pesticide, which leaves the plant vulnerable to pests capable of becoming immune to one type of pesticide.

Thus, a need exists for an apparatus and method of deterring or killing a wide variety of garden pests while avoiding the harmful risks of direct pesticide treatment. It is to such an apparatus and method that the inventive concepts disclosed herein are directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is cross-sectional view of a an apparatus for growing plants constructed in accordance with the inventive concepts disclosed herein and shown disposed partially below and partially in a ground surface.

FIG. 2 is a top perspective view of a planter constructed in accordance with the inventive concepts disclosed herein.

FIG. 3 is a cross sectional view of the planter of FIG. 2.

FIG. 4 is a front elevational view of a sack constructed in accordance with the inventive concepts disclosed herein.

FIG. 5 is a perspective view of a cage constructed in accordance with the inventive concepts disclosed herein.

### DETAILED DESCRIPTION OF EXEMPLARY EMBODIMENTS

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts disclosed and claimed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements or steps is not necessarily limited to only those elements or steps and may include other elements, steps, or features not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Throughout this disclosure and the claims, the terms “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, or combinations thereof, for example.

The use of the term “at least one” will be understood to include one as well as any quantity more than one, including but not limited to each of, 2, 3, 4, 5, 10, 15, 20, 30, 40, 50, 100, and all integers therebetween. The term “at least one” may extend up to 100 or 1000 or more, depending on the term to which it is attached; in addition, the quantities of 100/1000 are not to be considered limiting, as higher limits may also produce satisfactory results. Singular terms shall include pluralities and plural terms shall include the singular unless indicated otherwise.

The term “or combinations thereof” as used herein refers to all permutations and/or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment, although the inventive concepts disclosed herein are intended to encompass all combinations and permutations including one or more of the features of the embodiments described herein.

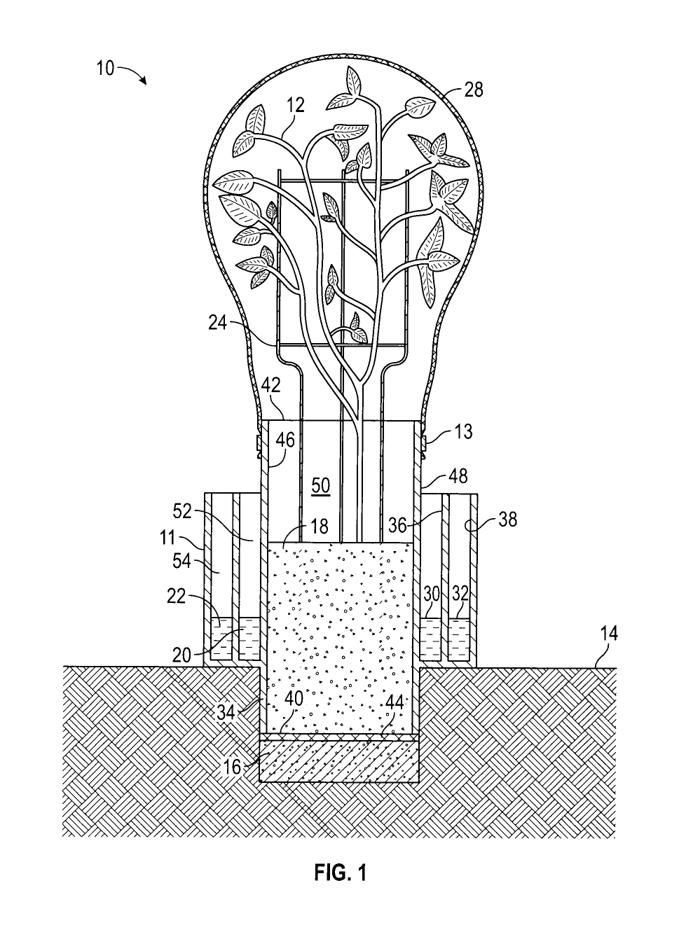

Referring now to FIG. 1, an apparatus 10 for growing a plant, such as plant 12, is illustrated. In one embodiment, the apparatus 10 may include a planter 11, a cage 24, and a sack 28. A portion of the planter 11 (described in further detail below) is disposed below a ground surface 14 and is positioned above a layer of rock 16, which is disposed below the ground surface 14. The plant 12 and a volume of soil 18 are disposed in the planter 11. The apparatus 10 is constructed to protect the plant 12 from a variety of garden pests (not shown) with the use of isolated chemical pesticides, such as chemical pesticides 20 and 22. The plant 12 is supported by the cage 24, a portion of which is disposed in the volume of soil 18, and another portion of which extends above the planter 11. The sack 28 is disposed about the plant 12 for protecting the plant 12 for jumping and flying garden pests (not shown). An elastic band 13 surrounds the sack 28 and the planter 11 to seal the sack 28 to the planter 11 and further protect the plant 12 from such pests.

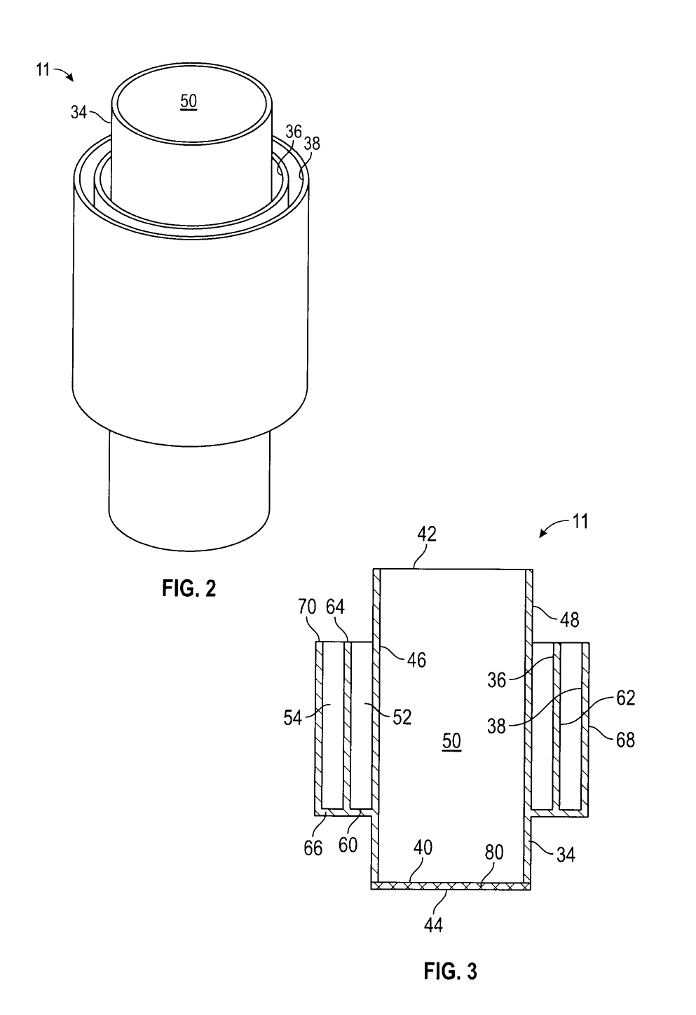

Referring now to FIGS. 1-3, the planter 11 includes a tubular member 34, a first annular structure 36 extending from the tubular member 34, a second annular structure 38 extending from the first annular structure 36, and a screen 40 (shown in FIGS. 1 and 3) extending across a bottom end of the tubular member 34. It should be appreciated that the planter 11 may include fewer or less annular structures than two. For example, the planter 11 may include, but is not limited to including, one, three, or four annular structures.

The tubular member 34 has a top end 42, a bottom end 44, an interior surface 46, and an exterior surface 48. The tubular member 34 defines a plant receiving chamber 50, in which the volume of soil 18 and the plant 12 are disposed. A portion of the tubular member 34 may be positioned below the ground surface 14 and a portion of the tubular member 34 may be positioned above the ground surface 14. Specifically, in at least one embodiment, approximately eight inches of the tubular member 34 may be positioned below the ground surface 14, and approximately ten inches of the tubular member 34 may be positioned above the ground surface 14.

The tubular member 34 may be constructed of variety of shapes, including but not limited to, cylinders, rectangles, and squares, and may constructed of a variety of sizes. For example, the cross section diameter of the cylindrical tubular member 34 may be between, but is not limited to being between, about four inches and about eight inches. Specifically, in at least one embodiment, the cross section diameter of the tubular member 34 is about six inches. The height of the tubular member 34 may be between, but is not limited to be being between, about sixteen inches and about twenty inches. Specifically, in at least one embodiment, the height of the tubular member 34 is about eighteen inches. The tubular member 34 may also be constructed of a variety of materials including, but not limited to, plastic, metal, or a combination thereof.

The first annular structure 36 extends from the exterior surface 48 of the tubular member 34 in a way to define a first annular channel 52 about the tubular member 34. As shown in FIG. 1, the chemical pesticide 20 may be disposed in the first annular channel 52 up to a fill line 30.

In the embodiments shown in FIGS. 1-3, the first annular structure 36 includes a bottom wall 60 and at least one sidewall 62 extending from the bottom wall 60. A top end 64 of the sidewall 62 may be lower than the top end 42 of the tubular member 34.

The first annular structure 36 may be constructed of a variety of shapes, sizes, and materials. For example, the shape of the first annular structure 36 may constructed to correspond to the shape of the tubular member 34 and may be constructed in a cylindrical or U-shape. Alternatively, the first annular structure 36 may be constructed in an L-shape. The first annular structure 36 may have the same height as the tubular member 34 or may have a lesser height than the tubular member 34. Specifically, in at least one embodiment, where the height of the annular structure 36 is less than the height of the tubular member 34, the height of first annular structure 36 is six inches. The sidewall 62 of the first annular structure 36 may extend between, but is not limiting to extending between, about one inch and about three inches from the bottom wall 60. Specifically, in at least one embodiment, the sidewall 62 extends about two inches from the bottom wall 60. The first annular structure 36 is constructed of at least one fluid impermeable material. Such materials may include, but are not limited to, plastic, metal, or any other fluid impermeable material known in the art.

The second annular structure 38 extends from the first annular structure 36 in a way to define a second annular channel 54 about the first annular structure 36. As shown in FIG. 1, the chemical pesticide 22 may be disposed in the second annular channel 54 up to a fill line 32.

In the embodiments in FIGS. 1-3, the second annular structure 38 includes a bottom wall 66 and at least one sidewall 68 extending from the bottom wall 66. A top end 70 of the sidewall 68 may be lower than the top end 42 of the tubular member 34. For purposes of conciseness, it is noted that the second annular structure 38 may be constructed of the same shapes and sizes as the first annular structure. Specifically, in at least one embodiment, the height of second annular structure 38 may be about six inches, and the sidewall 68 of the second annular structure 38 may extend about two inches from the bottom wall 66. The second annular structure 38 is constructed of at least one fluid material and may be constructed of the same materials as the first annular structure 36.

The first and second annular structures 36 and 38 are designed to isolate the plant 12 disposed in the plant receiving chamber 50 from the chemical pesticides 20 and 22 disposed in the first and second annular channels 52 and 54, respectively. In this way, toxins may be used to deter garden pests that might otherwise crawl or climb on the planter 11 to access the plant 12, while at the same time, toxic contamination of the plant 12, the volume of soil 18, and earth below the ground surface 14 may be prevented. In addition to the first annular structure 36, the second annular structure 38 further prevents crawling and climbing garden pests from accessing the plant 12 by providing another barrier to such pests. Chemical pesticide 20 may be a different type of chemical pesticide than chemical pesticide 22 such that different types of garden pests susceptible to varying types of chemical pesticides may be deterred. A crawling garden pest may be required to crawl up and down the sidewalls 62 and 68 and encounter chemical pesticide 20 and 22 before accessing the plant receiving space 50 of the tubular member 34.

The screen 40 (shown in FIGS. 1 and 3) extends across the bottom end 44 of the tubular member 34. The screen 40 is formed of a mesh 80. The mesh 80 is sized to allow fluids to exit the plant receiving chamber 50 through the bottom end 44 of the tubular member 34 and is sized to inhibit garden pests from entering the plant receiving chamber 50 through the bottom end 44 of the tubular member 34. The screen 40, therefore, may deter burrowing and root destroying garden pests (including but not limited to, beetles, larvae, grubs, and worms) from accessing the plant 12 while also allowing water to drain from the volume of soil 18.

The screen 40 may be constructed of a size and shape that corresponds to the width of the tubular member 34. Specifically, in at least one embodiment, the screen 40 is circular and may have a cross section diameter of about six inches. The screen 40 may also be formed of a variety of materials, including but not limited to, stainless steel, copper, or aluminum.

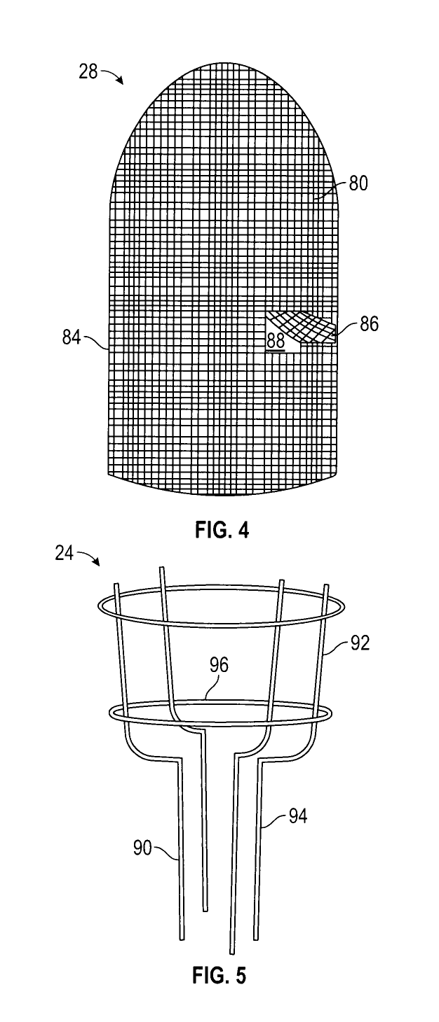

As shown in FIGS. 1 and 4, the sack 28 is disposable about the top end 42 of the tubular member 34. In FIG. 1, the sack 28 is disposed about the plant 12 for protecting the plant 12 from flying and jumping garden pests, including but not limited to, cabbage moths, birds, and grasshoppers. As shown in FIG. 4, the sack 28 may include a body 84 and a flap 86. The flap 86 is releasably attached to the body 84 of the sack 28. When the flap 86 is in a released position, water may be administered through an opening 88 of the sack 28 and to the plant 12 disposed in the plant receiving chamber 50.

The sack 28 may be shaped and sized to correspond with the width of the tubular member 34 and the height of the plant 12. Specifically, in at least one embodiment, the sack 28 may have a height of about thirty six inches and a width of about twenty six inches. The sack 28 is constructed of at least one air permeable material and of at least one light permeable material. Such materials may include, but are not limited to, knitted or micro-mesh polyethylene fabric. The flap 86 may be secured to the body 84 of the sack 28 by a variety of methods, including but not limited to, the use of a hook and loop material.

As shown in FIG. 1, the elastic band 13 surrounds the sack 28 and the top end 42 of the tubular member 34 forming a seal between the sack 28 and the tubular member 34. This way, garden pests that land on the sack 28 may either crawl down into the chemical pesticide 20 or 22 (if small enough) or may jump or fly away since they may not access the plant 12.

The elastic band 13 is sized to correspond with the width of the tubular member 34 and may be formed of a variety of elastic materials including, but not limited to, rubber. In other embodiments, other devices, including, but not limited to, drawstrings or clamps may be used to secure the sack 28 to the tubular member 34.

Referring now to FIGS. 1 and 5, the cage 24 is constructed to support the plant 12. The cage 24 includes a bottom portion 90 and an upper portion 92. The cage 24 may also include a plurality of legs 94 supported by a plurality of rings 96. As shown in FIG. 1, the bottom portion 90 of the cage 24 is disposed in the plant receiving chamber 50 and in the volume of soil 18. The upper end 92 of the cage 24 is positioned above the top end 42 of the tubular member 34. The cage 24 is isolated from the first and second annular structures 36 and 38 and is disposed within the sack 28 thereby preventing pests from accessing the cage 24 and the plant 12 it supports.

The legs 94 of the cage 24 are sized to be disposed in the plant receiving chamber 50 and support the plant 12. The cage 24 may be constructed of a variety of shapes, and cages for supporting plants, such as tomato cages, are well known in the art. Specifically, in at least one embodiment, the legs 94 bend where the bottom potion 90 meets the upper portion 92, and the upper portion 92 bows outwardly to accommodate the girth of the plant 12. In other embodiments, the legs 94 may taper such that the upper portion 92 is wider than the bottom portion 90. The height of the bottom portion 90 of the cage 24 may generally correspond to the height of the tubular member 24, and the height of the upper portion 92 of the cage 24 may generally correspond to the height of a mature plant, such as plant 12. The cage 24 may be constructed of a variety of materials including, but not limited to, powder-coated galvanized steel or any other material known in the art.

Referring now to FIG. 1, a method of growing a plant, such as plant, 12 is described. First, an amount of earth is removed to create a hole below the ground surface 14. Any suitable object for removing earth including, but not limited to, a post hole digger, may be used to remove the earth. Where the tubular member 34 is cylindrical in shape, the hole may be between, but is not limited to being between, four and eight inches in diameter, depending on the cross section diameter of the tubular member 34 of the planter 11. The hole may be between, but is not limited to being between, seven and eleven inches deep. Specifically, in at least one embodiment, a six inch circular hole is dug nine inches deep in the earth to accommodate a bottom portion of the tubular member 34.

Next, the layer of rock 16 is added into the hole. The layer of rock 16 may be between, but is not limited to being between, one half and two inches deep. Specifically, in at least one embodiment, the layer of rock 16 is one inch deep. The layer of rock 16 may be composed of a variety of rocks including, but not limited to, diatomaceous earth, a naturally occurring, soft, siliceous sedimentary rock. Then, the planter 11 is added into the hole such that the bottom end 44 of the tubular member 34 is atop the layer of rock 16 and such that the bottom walls 60 and 66 of the first and second annular structures 52 and 43, respectively, are atop the ground surface 14. Any gaps around the hole and the tubular member 34 are filled with a layer of rock or soil, such as the same materials that comprise the layer of rock 16.

Then, the volume of soil 18 is added to and compressed within the plant receiving chamber 50 of the tubular member 34. The volume of soil 18 may be between, but is not limited to being between, twelve and sixteen inches deep when compressed. Specifically, in at least one embodiment, the volume of soil 18 is fourteen inches deep when compressed. New organic soil or some other type of certified organic compositing or potting soil may be used to avoid infestation by pests that may be found in regular grade potting soil.

All of the leaves and stems of plant 12 may be washed prior to planting the plant 12 in the plant receiving chamber 50. Washing may reduce the chances of pest infestation. Once washed, the plant 12 is transferred into the plant receiving chamber 50 of the tubular member 34.

Next, chemical pesticide 20 is added to first annular channel 52 and filled to the fill line 30. Then chemical pesticide 22 is added to the second annular channel 54 and filled to the fill line 32. In at least one embodiment, the fill lines 30 and 32 may each be two inches above the bottom walls 60 and 66 of the first and second annular structures 36 and 38, respectively.

Having low fill lines 30 and 32 relative to the height of the first and second annular structures 52 and 53 may provide at least two benefits: first, the low fill lines 30 and 32 may prevent birds and other living creatures from accessing the chemical pesticides 20 and 22 disposed in the first and second annular channels 52 and 54; and second, the low fill lines 30 and 32 may accommodate heavy rain fall and excess water from watering the plant 12. If liquid does exceed the fill lines 30 and 32, then first and second annular channels 52 and 54 may be drained with the use of a syringe and tubing. In embodiments where the top ends 64 and 70 of the first and second annular structures 36 and 38 are lower than the top end 42 of the tubular member 34, any excess liquid from rain fall or watering that exceeds the height of the top ends 64 and 70 may not overflow into the plant receiving chamber 50 of the tubular member 34.

As mentioned above, chemical pesticides 20 and 22 may be composed of two separate chemical formulas to target garden pests, such as spider mites, that may be able to adapt or become immune to one type of chemical pesticide. Predator insects, such as lady bugs or predator mites, may be added to the plant receiving chamber 50 for additional protection of the plant 12 from garden pests.

Once the plant 12 is disposed in the plant receiving chamber 50, the cage 24 is added about the plant 12 by pressing the legs 94 into the volume of soil 18 and positioning the rings 96 to surround the girth of the plant 12. Then, the sack 28 is disposed about the plant 12 and about the cage 24. The elastic band 13 is then placed over the sack 28 and disposed around the exterior surface 48 and at the top end 42 of the tubular member 34 forming a tight seal between the sack 28 and the tubular member 34.

To water the plant, the flap 86 (shown in FIG. 4) of the sack 28 is released and a water hose may be used to administer water through the opening 88 of the sack 28 and to the plant 12 disposed in the plant receiving chamber 50.

From the above description, it is clear that the present inventive concept is well adapted to carry out the objects and to attain the advantages mentioned herein as well as those inherent in the invention. While exemplary embodiments of the invention have been described for purposes of this disclosure, it will be understood that numerous changes may be made which will readily suggest themselves to those skilled in the art and which are accomplished within the spirit of the inventive concept disclosed and claimed herein.

What is claimed is:

1. An apparatus for growing plants, comprising:
a tubular member having a top end, a bottom end, an interior surface, and an exterior surface, the tubular member defining a plant receiving chamber;
an annular structure extending from the exterior surface of the tubular member in a way to define an annular channel about the tubular member, the annular structure constructed of at least one fluid impermeable material; and
a screen extending across the bottom end of the tubular member, the screen formed of a mesh sized to allow fluids to exit the plant receiving chamber through the bottom end of the tubular member and sized to inhibit pests from entering the plant receiving chamber through the bottom end of the tubular member.

2. The apparatus of claim 1, wherein the annular structure comprises a bottom wall and at least one sidewall extending from the bottom wall.

3. The apparatus of claim 2, wherein a top end of the sidewall of the annular structure is lower than the top end of the tubular member.

4. The apparatus of claim 1, further comprising a sack disposable about the top end of the tubular member, wherein the sack is constructed of at least one air permeable material and of at least one light permeable material.

5. The apparatus of claim 4, wherein the sack further comprises a body and a flap releasably attached to the body of the sack in a way that water may be administered through an opening of the sack and to the plant receiving chamber of the tubular member when the flap is in a released position.

6. The apparatus of claim 4, further comprising an elastic band surrounding the sack and surrounding the top end of the tubular member such that the elastic band forms a seal between the sack and the tubular member.

7. The apparatus of claim 1, further comprising a cage for supporting a plant, a bottom portion of the cage configured to be disposed in the tubular member with an upper portion of the cage positioned above the top end of the tubular member, wherein a sack is disposable about the cage.

8. The apparatus of claim 7, wherein the cage is isolated from the annular structure and is disposed within the sack such that pests are prevented from accessing the cage and a plant supported by the cage.

9. An apparatus for growing plants, comprising:
a tubular member having a top end, a bottom end, an interior surface, and an exterior surface, the tubular member defining a plant receiving chamber;
a first annular structure extending from the exterior surface of the tubular member in a way to define a first annular channel about the tubular member, the annular structure constructed of at least one fluid impermeable material; and
a second annular structure extending from the first annular structure in a way to define a second annular channel about the first annular channel, the second annular structure constructed of at least one fluid impermeable material; and
a screen extending across the bottom end of the tubular member, the screen formed of a mesh sized to allow fluids to exit the plant receiving chamber through the bottom end of the tubular member and sized to inhibit pests from entering the plant receiving chamber through the bottom end of the tubular member.

10. The apparatus of claim 9, wherein the first annular structure comprises a bottom wall and at least one sidewall extending from the bottom wall, and wherein the second annular structure comprises a bottom wall and at least one sidewall extending from the bottom wall.

11. The apparatus of claim 10, wherein a top end of the sidewall of the first annular structure is lower than the top end of the tubular member, and wherein a top end of the sidewall of the second annular structure is lower than the top end of the tubular member.

12. The apparatus of claim 9, further comprising a sack disposable about the top end of the tubular member, wherein the sack is constructed of at least one air permeable material and of at least one light permeable material.

13. The apparatus of claim 12, wherein the sack further comprises a body and a flap releasably attached to the body of the sack in a way that water may be administered through an opening of the sack and to the plant receiving chamber of the tubular member when the flap is in a released position.

14. The apparatus of claim 12, further comprising an elastic band surrounding the sack and surrounding the top end of the tubular member such that the elastic band forms a seal between the sack and the tubular member.

15. The apparatus of claim 9, further comprising a cage for supporting a plant, the bottom portion of the cage configured to be disposed in the tubular member with an upper portion of the cage positioned above the top end of the tubular member, wherein a sack is disposable about the cage.

16. The apparatus of claim 15, wherein the cage is isolated from the first annular structure and the second annular structure and is disposed within the sack such that pests are prevented from accessing the cage and a plant supported by the cage.

17. A kit for growing plants, comprising:
a planter comprising:
a tubular member having a top end, a bottom end, an interior surface, and an exterior surface, the tubular member defining a plant receiving chamber;
a first annular structure extending from the exterior surface of the tubular member in a way to define a first annular channel about the tubular member, the annular structure constructed of at least one fluid impermeable material; and
a second annular structure extending from the first annular structure in a way to define a second annular channel about the first annular channel, the second annular structure constructed of at least one fluid impermeable material; and
a screen extendable across the bottom end of the tubular member, the screen formed of a mesh; and
a sack disposable about the top end of the tubular member, wherein the sack is constructed of at least one air permeable material and of at least one light permeable material; and
a cage for supporting a plant, the bottom portion of the cage configured to be disposed in the tubular member with an upper portion of the cage positioned above the top end of the tubular member, wherein a sack is disposable about the cage.

18. The kit of claim 17, wherein the sack further comprises a body and a flap releasably attached to the body of the sack.

19. The kit of claim 18, further comprising an elastic band constructed to surround the sack and the top end of the tubular member.

20. The kit of claim 17, wherein the annular structure is a first annular structure, and wherein the planter further comprises a second annular structure extending from the first annular structure in a way to define a second annular channel about the first annular channel, the second annular structure constructed of at least one fluid impermeable material.
